(19) United States
(12) Patent Application Publication
(10) Pub. No.: US 2017/0367923 A1
(43) Pub. Date: Dec. 28, 2017

(54) A MULTI-PURPOSE APPARATUS FOR TREATING AN ANIMAL

(71) Applicant: AMANDEL OY, Jääli (FI)

(72) Inventor: Jarmo BERGBACKA, Jääli (FI)

(73) Assignee: AMANDEL OY, Jääli (FI)

(21) Appl. No.: 15/543,755

(22) PCT Filed: Jan. 20, 2016
(86) PCT No.: PCT/FI2016/050026

§ 371 Date: Jul. 14, 2017

(30) Foreign Application Priority Data
Jan. 30, 2015 (FI) 20155065

(51) Int. Cl. A61H 11/00; A61H 39/08; A01K 13/00; A61H 23/02

(52) U.S. Cl. CPC A61H 11/00; A61H 23/02; A61H 39/08; A01K 13/002; A61H 2201/5071; A61H 2201/5015; A61H 2201/1685; A61H 2201/0153; A61H 2201/0107; A61H 2011/005; A61H 2201/5097; A61H 2203/03; A61H 2230/505; A61H 2201/1645

(57) ABSTRACT

A multi-purpose apparatus for treating an animal. The apparatus includes at least two vibrators; a massage head coupled with the at least two vibrators; a controller configured to control the at least two vibrators such that they generate a variable beat frequency to the massage head; and a housing accommodating the at least two vibrators, the massage head, and the controller. The massage head comprises a concave curvature to follow contours of the animal so that the concave curvature becomes in contact with a musculoskeletal system of the animal, the massage head is coupled with the at least two vibrators so that two vibrators are positioned at opposite ends of the concave curvature. The massage head is adapted and dimensioned such that an interchangeable curry brush curved to follow the contours of the animal is coupleable with the massage head.

### FIELD

The invention relates to a multi-purpose apparatus for treating an animal.

### BACKGROUND

Various apparatuses for treating animals are well-known. Typically these are separate apparatuses, each designed for their specific task.

### BRIEF DESCRIPTION

The present invention seeks to provide an improved multi-purpose apparatus for treating an animal.

According to an aspect of the present invention, there is provided an apparatus as specified in claim 1.

The multi-purpose apparatus provides a tool for treating an animal with a novel combination of features. The apparatus may be used for massaging the animal with a massage head, or, alternatively, for grooming the animal with a curry brush. Both the massage head and the curry brush are curved to follow contours of the animal. Furthermore, the apparatus includes at least two vibrators controlled such that they generate a variable beat frequency to the massage head. The combination of these features provides several advantages. The same apparatus may be used both for massaging and grooming the animal. The apparatus provides better massage and grooming results as it is curved to follow the contours of the animal. And, finally, the variable beat frequency enhances massage and grooming results of the animal, and makes the massage and grooming more effective for the animal and easier for the user. When grooming or massaging large animals such as horses, the variable beat frequency makes the work less tiring for the user. The grooming results are improved as the variable beat frequency removes dirt and dead skin cells from the depths of the coat of the animal, thus providing a deep cleansing effect.

### LIST OF DRAWINGS

Example embodiments of the present invention are described below, by way of example only, with reference to the accompanying drawings, in which

FIG. 1 illustrates example embodiments of an apparatus;

FIGS. 2, 3, 4, 14 and 15 illustrate example embodiments relating to the use of the apparatus; and

FIG. 5 illustrates an example embodiment of generating a beat frequency;

FIGS. 6A, 6B, 6C, 6D, 6E, 6F, 6G, 7, 8A, 8B, 9A, 9B, 10A, 10B, 10C, 11, 12, 13A, 13B, 13C and 13D illustrate further example embodiments of the apparatus.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

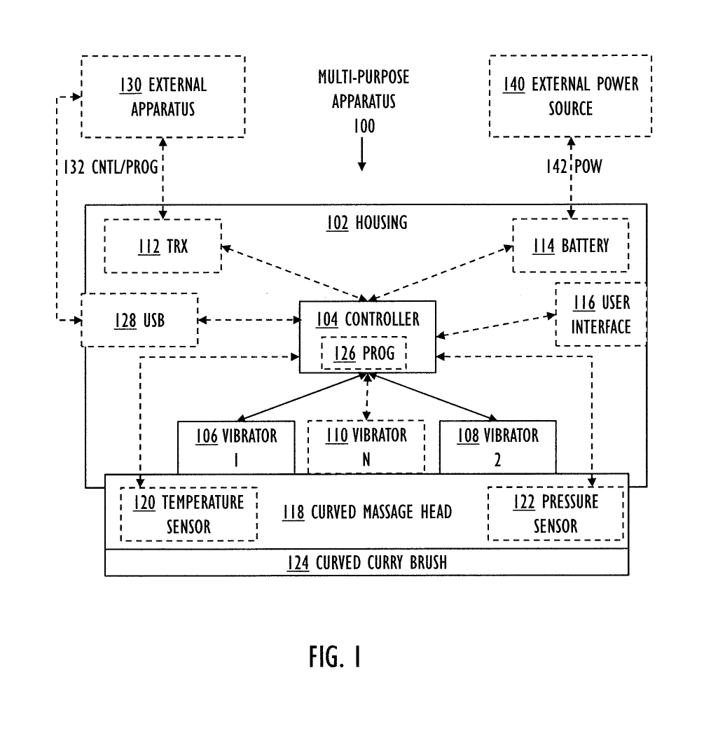

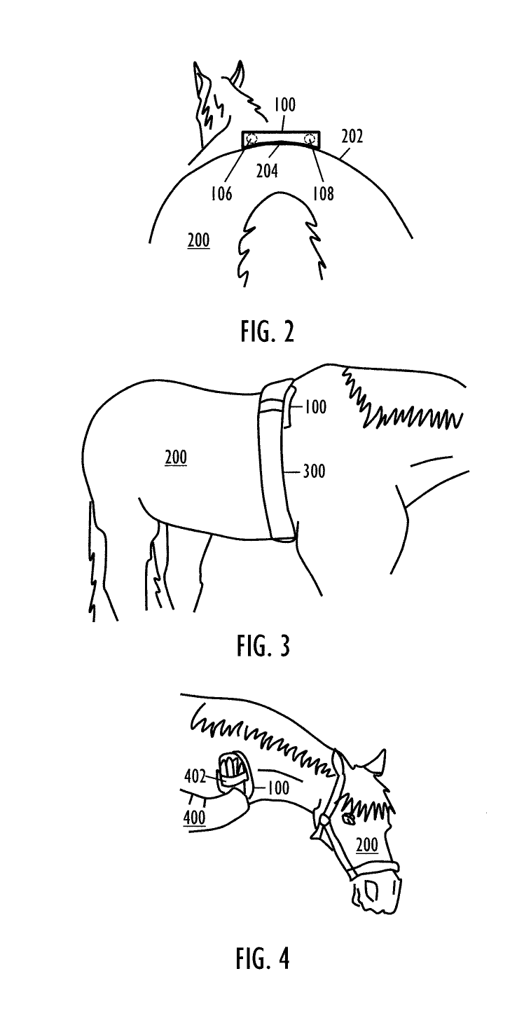

FIG. 1 illustrates example embodiments of a multi-purpose apparatus 100 for treating an animal 200 as illustrated in FIGS. 2, 3 and 4.

The apparatus 100 comprises at least two vibrators 106, 108, 110. As shown in FIG. 1, the number of the vibrators 106, 108, 110, may vary from 2 to N, where N is any integer greater than two.

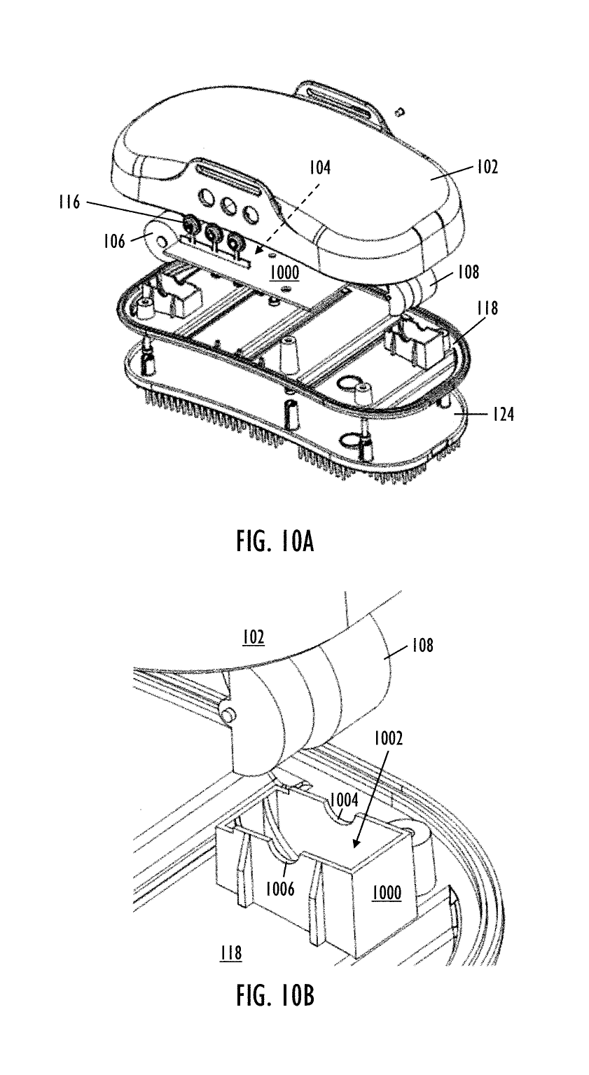

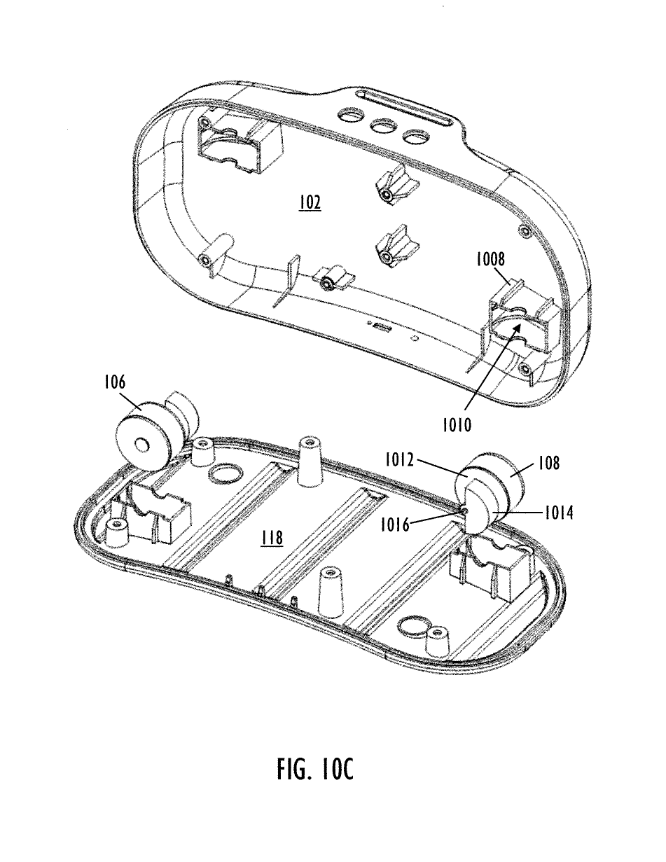

In an example embodiment illustrated in FIG. 10C, the vibrator 106, 108, 110 comprises an electric motor 1012 with an unbalanced mass 1014 coupled with a driveshaft 1016 of the electric motor 1012. The vibrator 106, 108, 110 generates vibrations (mechanical oscillations) as the unbalanced mass 1014 is rotated by the driveshaft 1016. The vibrations may be generated in x and/or y and/or z directions, as deemed fit in the designing phase of the apparatus 100. Furthermore, these directions may also be controlled at least to some degree during the use of the apparatus 100. In an example embodiment, the frequency range of the vibrations is from 0 to 2 kHz, for example.

The apparatus 100 also comprises a massage head 118, curved 204 to follow contours 202 of the animal 200, and coupled with the at least two vibrators 106, 108, 110.

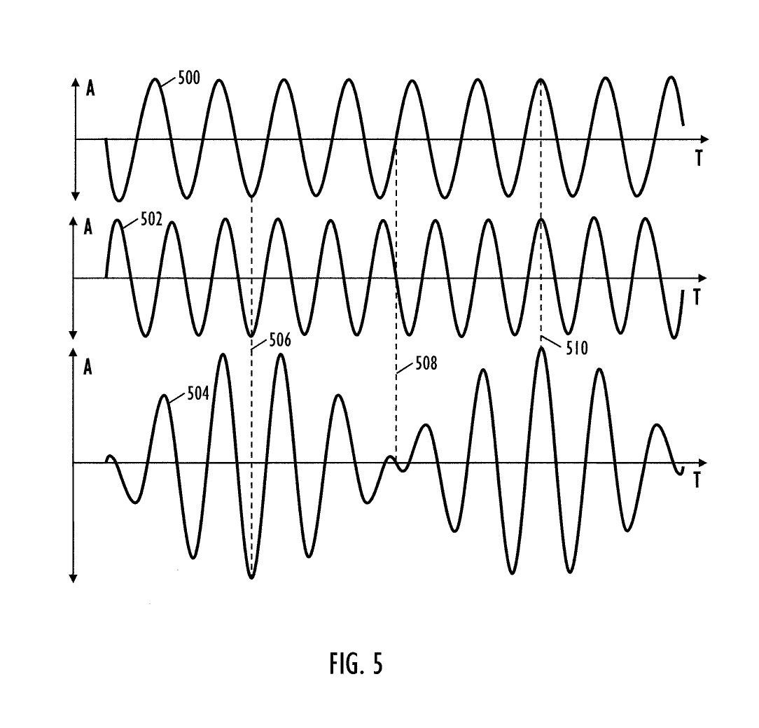

The apparatus 100 also comprises a controller 104 configured to control the at least two vibrators 106, 108, 110 such that they generate a variable beat frequency 504, illustrated in FIG. 5, to the massage head 118.

In FIG. 5, two sine waves 500, 502 illustrate oscillations produced by the two vibrators 106, 108, and the variable beat frequency 504 is the sum of the two sine waves 500, 502. As can be seen, when the two sine waves 500, 502 are in-phase 506, 510, the resulting variable beat frequency 504 has a larger amplitude wave as a result of the amplification. When the two sine waves 500, 502 are out-of-phase 508, the resulting variable beat frequency 504 has a smaller amplitude wave as a result of the cancellation

The variable beat frequency 504 generates a variety of perceived sensations on the treated animal 200. The sensation varies depending on the amplitude and frequency of the variable beat frequency 504. Additionally, by varying a pattern of the variable beat frequency 504, a variety of different treatments may be realized.

The apparatus also comprises a housing 102 accommodating the at least two vibrators 106, 108, 110, the massage head 118, and the controller 104.

Furthermore, the massage head 118 is adapted and dimensioned such that an interchangeable curry brush 124 curved 204 to follow the contours 202 of the animal 200 is coupleable with the massage head 118. In an example embodiment, the curry brush 124 comprises teeth (arranged in rows or in some other form). The density of the teeth may be varied depending on the type of the animal 200, or depending on the desired effect. The animal 200 is groomed with the curry brush 124 in order to help loosen dirt and hair, and stimulate the skin to produce natural oils, for example.

In such a way, the apparatus becomes a multi-purpose apparatus 100. The curved massage head 118 may be used to massage the animal 200. The curved interchangeable curry brush 124 coupled with the massage head 118 may be used to groom the animal 200.

The massage head 118 and the curry brush 124 are “curved” 204 to follow the contours 202 of the animal 200. In an example embodiment, the contours 202 of the animal 200 refer to “terrain” of the animal 200, determined by a musculoskeletal system of the animal 200. Naturally, this terrain varies depending on the treated body part, but the curvature 204 may be designed such that it generally fits: if the treated animal 200 is a horse, for example, the curvature 204 is made to fit the large muscle groups on the back, sides and neck, for example.

The curvature 204 may be rigid or flexible, depending on the material: if it is rigid, the curvature 204 remains the same during the treatment, but if it is flexible, the user 400 may flex the massage head 118 and/or the curry brush 124 such that the curvature 204 is increased in order to follow the contours 202 even more closely. This means that the flexible curvature 204 is steplessly adjustable. The rigid curvature 204 may also be adjustable, but stepwise, meaning that the massage head 118 and/or the curry brush 124 comprises sections that may be pivotably lockable in relation to each other.

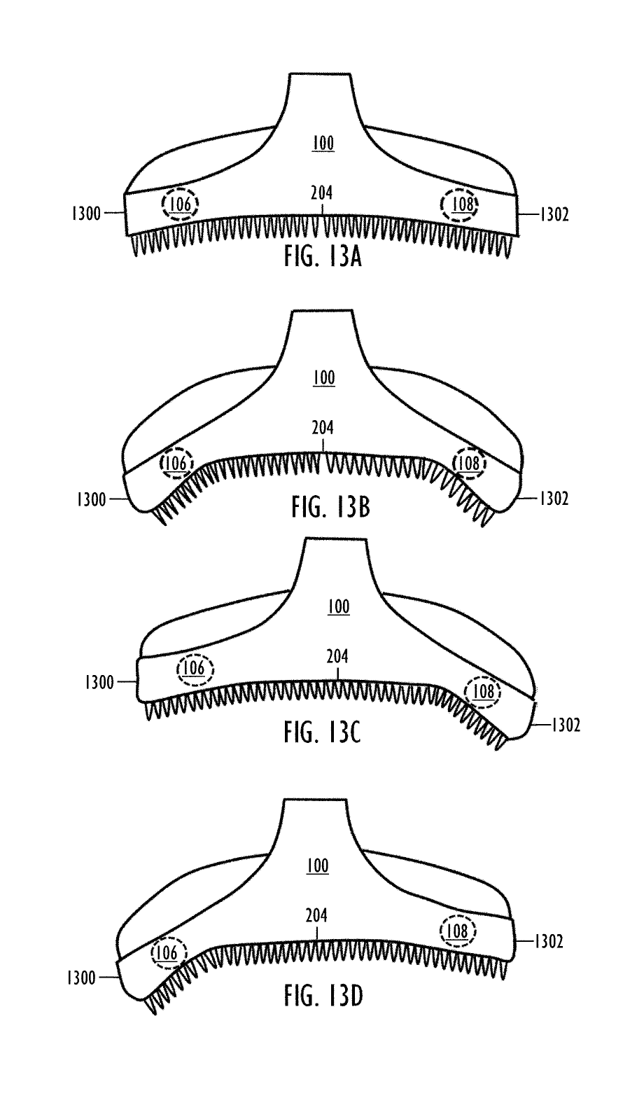

FIGS. 13A, 13B, 13C, 13D, 14 and 15 illustrate the concave curvature 204 in more detail.

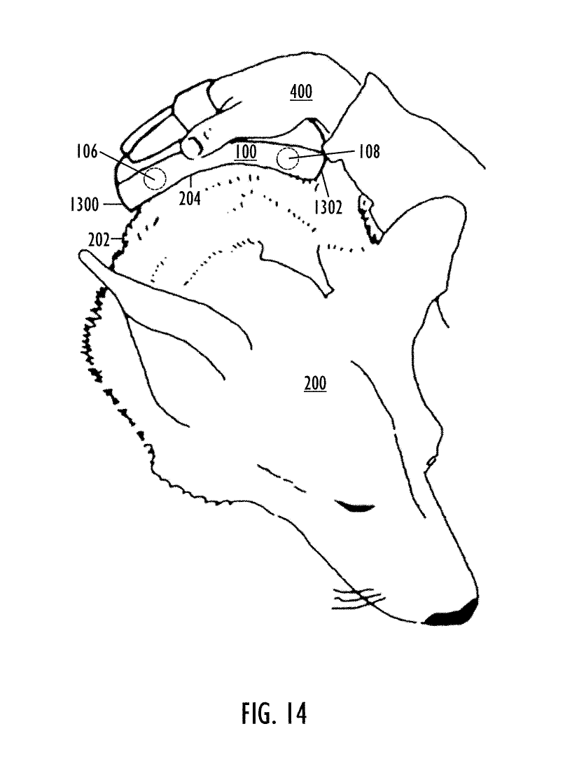

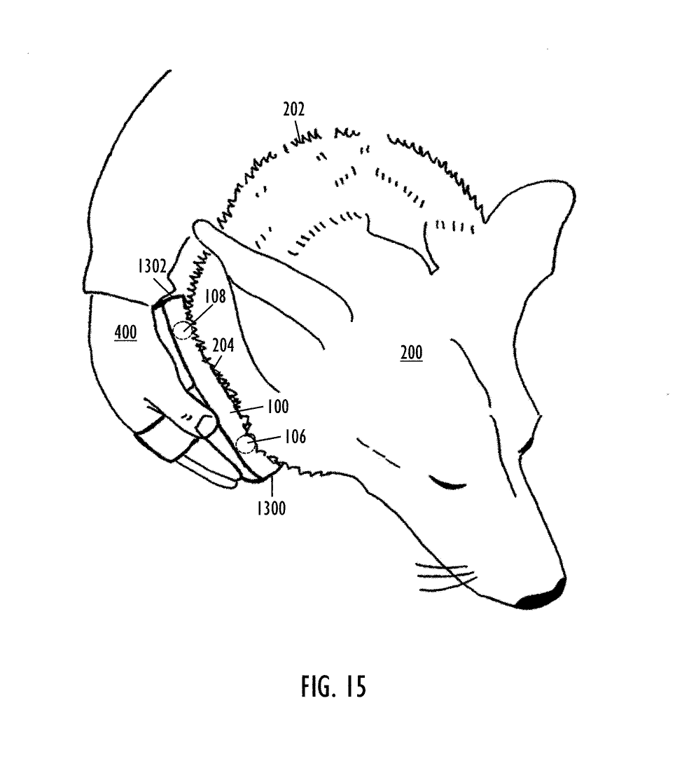

FIGS. 14 and 15 illustrate how a user 400 treats a dog 200 with the apparatus 100.

As shown in FIGS. 14 and 15, the concave curvature 204 follows contours 202 of the animal 200 so that the concave curvature 204 becomes in contact with a musculoskeletal system of the animal 200.

As shown in FIG. 10A, the massage head 118 is coupled with the at least two vibrators 106, 108, 110 so that two vibrators 106, 108 are positioned at opposite ends of the concave curvature (204). In FIGS. 13A, 13B, 13C, 13D, 14 and 15, the opposite ends of the curvature 204 are marked with reference numerals 1300 and 1302.

In an example embodiment, the concave curvature 204 is flexible. If we compare FIGS. 14 and 15, the concave curvature 204 is increased in FIG. 14, whereas in FIG. 15 the concave curvature 204 is decreased. This is also shown in FIGS. 13A and 13B: in FIG. 13A, the concave curvature 204 is in its default position, whereas in FIG. 13B, the concave curvature 204 is steeper.

FIG. 13B also illustrates that both opposite ends 1300, 1302 may be flexed. In FIG. 13C only the other end 1300 is flexed, and in FIG. 13D, the opposite end 1302 is flexed. Accordingly, the apparatus 100 may be designed and manufactured so that both ends 1300, 1302 are flexible, or, alternatively, so that only one of the ends 1300/1302 is flexible.

As was explained earlier, the concave curvature 204 may be flexible and steplessly adjustable so that a user 400 may flex the massage head 118 such that the curvature 204 is increased in order to follow the contours 202 even more closely. This effect is clearly shown in FIG. 14.

Or, alternatively, the concave curvature 204 is rigid and stepwise adjustable as the massage head 118 comprises sections 1300, 1302 that are pivotably lockable in relation to each other so that the user 400 may adjust the massage head 118 such that the curvature 204 is increased in order to follow the contours 202 even more closely.

The combination of the explained features provides the multi-purpose apparatus with enhanced effectivity. The treated animal 200 also receives medical benefits, such as at least one of the following: an improved skin/hair health, an improved relaxation (muscular, psychological, and neurological, possibly in the form of psycho-physical animal therapy), and an improved drainage of the lymph carrying waste products away from the tissues back toward the heart.

In an example embodiment, the controller 104 is implemented as an electronics module, which comprises one or more processors, and one or more memories including computer program code. The one or more memories and the computer program code are configured to, with the one or more processors, cause the controller 104 to control functions of the apparatus 100.

The term ‘processor’ refers to a device that is capable of processing data. Depending on the processing power needed, the apparatus 100 may comprise several processors such as parallel processors or a multicore processor. When designing the implementation of the processor, a person skilled in the art will consider the requirements set for the size and power consumption of the apparatus 100, the necessary processing capacity, production costs, and production volumes, for example. The processor and the memory may be implemented by an electronic circuitry.

The term ‘memory’ refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

In an example embodiment, a system clock constantly generates a stream of electrical pulses, which cause the various transferring operations within the apparatus 100 to take place in an orderly manner and with specific timing.

In an example embodiment, the processor may be implemented as a microprocessor implementing functions of a central processing unit (CPU) on an integrated circuit. The CPU is a logic machine executing a computer program code. The computer program code may be coded as a computer program using a programming language, which may be a high-level programming language, such as C++, C, or Java, or a low-level programming language, such as a machine language, or an assembler. The CPU may comprise a set of registers, an arithmetic logic unit (ALU), and a control unit (CU). The control unit is controlled by a sequence of the computer program code transferred to the CPU from the (working) memory. The control unit may contain a number of microinstructions for basic operations. The implementation of the microinstructions may vary, depending on the CPU design. The microprocessor may also have an operating system (a dedicated operating system of an embedded system, a real-time operating system, or even a general-purpose operating system), which may provide the computer program code with system services.

A non-exhaustive list of implementation techniques for the processor and the memory includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

The computer program code may be implemented by software and/or hardware. In an example embodiment, the software may be written by a suitable programming language, and the resulting executable code may be stored on the memory and run by the processor.

In an example embodiment, the functionality of the hardware may be designed by a suitable hardware description language (such as Verilog or VHDL), and transformed into a gate-level netlist (describing standard cells and the electrical connections between them), and after further phases the chip implementing the processor, memory and the code of the controller 104 may be fabricated with photo masks describing the circuitry.

In an example embodiment, the processor and the memory of the apparatus 100 are a part of a microcontroller, which may also comprise an USB (Universal Serial Bus) interface 128 and/or a wireless transceiver 112.

As illustrated in FIG. 10A, a printed circuit board 1000 may accommodate the controller 104 and some user interface 116 elements.

In an example embodiment, the apparatus 100 further comprises an interface 112, 128 to receive a program 132, 126 for the controller 104 to control the at least two vibrators 106, 108, 110 in order to offer a predetermined grooming treatment for the animal 200 with the apparatus 100, or a predetermined massage treatment for the animal 200 with the apparatus 100.

In an example embodiment, the apparatus 100 further comprises a temperature sensor 120 to measure temperature of a skin of the animal 200 treated with the apparatus 100, and the controller 104 is further configured to control the variable beat frequency 504 on the basis of the measured temperature such that at least one of the following is controlled: a frequency of the variable beat frequency 504, an amplitude of the variable beat frequency 504. In an example embodiment, the temperature sensor 120 is implemented as a thermistor (such as a negative temperature coefficient NTC thermistor), or an infra-red sensor, for example.

In an example embodiment, the apparatus 100 further comprises a pressure sensor 122 to measure a pressure subjected to a skin of the animal 200 treated with the apparatus 100, and the controller 104 is further configured to control the variable beat frequency 504 on the basis of the measured pressure such that at least one of the following is controlled: a frequency of the variable beat frequency 504, an amplitude of the variable beat frequency 504. In an example embodiment, the pressure sensor 122 is implemented as a pressure or force sensing element, for example.

In these two aforementioned example embodiments, the measured temperature or the measured pressure may indicate whether the treatment is too forceful or weak, and the amplitude and/or the frequency may be altered in order to achieve the desired intensity for the treatment.

Naturally, these two aforementioned example embodiments may be combined, meaning that both the measured temperature and the measured pressure indicate the intensity level of the treatment and possibly required changes.

The user interface 116 may give indications (with signal tones or lighting of a led, for example) to the user if a preset force and/or a preset temperature are exceeded.

With the measured temperature and/or measured pressure, a treatment program may be controlled. For example: the treatment is started with a basic program, and after the measured skin temperature is elevated (by a preset amount or over a preset threshold), the frequency and/or amplitude are increased. Another example: if the measured pressure increases, the alternation between the in-phase 506 and out-of-phase 508 of the variable beat frequency 504 is shortened, meaning that the rhythm of the treatment becomes faster.

With the measured temperature and/or measured pressure, a treatment program may be chosen: the treatment is started with a basic program, and after the measured skin temperature is elevated, another program with a faster and a varying rhythm is applied.

In an example embodiment illustrated in FIG. 3, the apparatus 100 further comprises a strap 300 attachable with the housing 102 such that the apparatus 100 is attachable to the animal 200, and a wireless radio transceiver 112 to exchange control data 132 with an external apparatus 130, and the controller 104 is controlled by the control data 132 in order to control a massage treatment of the animal 200 with the apparatus 100. The strap 300 may be made of flexible (synthetic) material and it may comprise a suitable fastener for adjusting the length and tightness such as a Velcro fastener. With this example embodiment, the user may remote-control the massage treatment of the animal 200. For example, the user attaches the apparatus 100 to the horse 200 with the strap 300, and as the horse 200 remains in a stall, the user may go in to a house, and do housework, and occasionally check with the external apparatus (a mobile telephone, a laptop computer, or a tablet computer, for example) 130 how the massage treatment is progressing, and, if necessary, control the massage treatment by changing the frequency and/or amplitude of the variable beat frequency 504.

In an example embodiment, the apparatus 100 further comprises a user interface 116, which implements the exchange of graphical, textual and/or auditory information with the user 400. The user interface 116 may be realized with various techniques, such as a display, means for producing sound, a keyboard, and/or a keypad, for example. The display may be a liquid crystal display (LCD), for example, but it may also be implemented by any appropriate technique, such as EL (electroluminescence), LED (light emitting diode), or organic light-emitting diode (OLED). The display may also incorporate other user interaction means, such as touch input, or haptic feedback, i.e. the display may be a multi-touch display. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, the user interface 116 may comprise other user interface components, for example various means for focusing a cursor (mouse, track ball, arrow keys, touch sensitive area etc.) or elements enabling audio control.

The housing 102 may be made of any suitable material such as plastic or metal.

Also the massage head 118 may be made of plastic, metal or some other suitable material, but it may also include natural material, such as wood, cotton, wool, rubber, textile, silicone, hemp, loofah (sponge) or some other product of the nature. The massage head 118 may also be made such that it tolerates the use of massage oil or liniment.

The body of the curry brush 124 may also be made of plastic, metal, or some other suitable material such as wood. The brushes of the curry brush 124 may be made of man-made material such as plastic, but they may also be made of natural material such as rubber or silicon, for example. In some cases stiff bristles may also be used, such as pig's bristle or boar's bristle, for example.

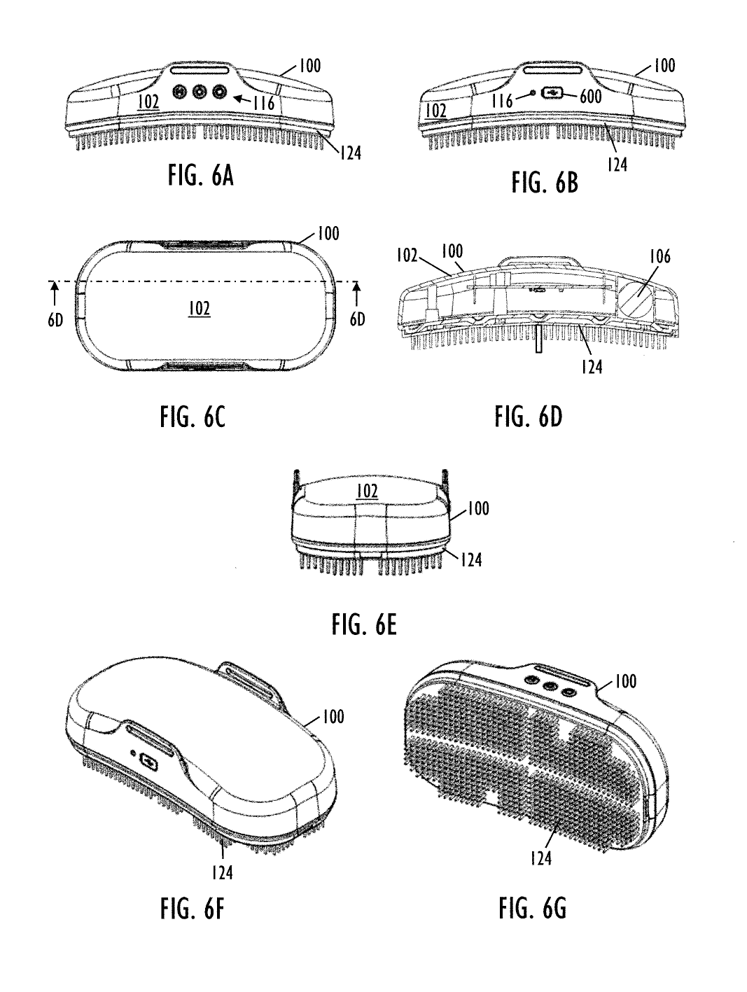

FIGS. 6A, 6B, 6C, 6D, 6E, 6F and 6G show different views of an example embodiment of the apparatus 100: the housing 102 and the curry brush 124 are clearly shown. Also the USB-port (covered by a shield) 128 is shown. The cross-section view of FIG. 6D also shows one of the vibrators 106. As a part of the user interface 116, FIG. 6A shows three buttons, and FIG. 6B shows a led. In an example embodiment, the buttons 116 are such that the first button is a mode selection switch (the modes being arranged as a loop, each mode defined by the amplitude and frequency of the variable beat frequency, for example), the second button is a power on/off switch, and the third button is a power setting switch (with a scale from 0 to 5, for example).

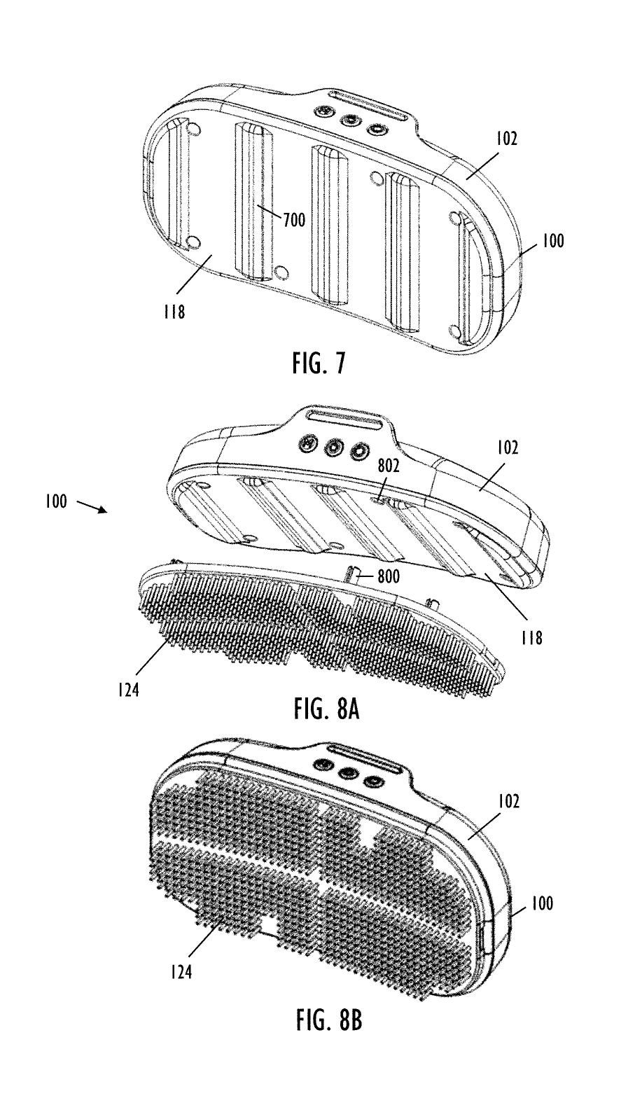

FIG. 7 illustrates an example embodiment of the apparatus 100, which shows the housing 102 and the massage head 118.

In an example embodiment, the massage head 118 is further adapted and dimensioned to be used for massaging the animal 200.

In an example embodiment, the massage head 118 may comprise ridges 700 designed to enhance the massage effect.

FIG. 8A illustrates an example embodiment of the apparatus 100, which shows the housing 102, the massage head 118, and the separate curry brush 124.

As can be seen, the curry brush 124 comprises pins 800, and the massage head 118 comprises slots 802. The pins 800 and slots 802 attach the curry brush 124 to the massage head 118.

In an example embodiment, the pin 800 and the counterpart slot 802 form a snap-fit joint. In a snap-fit joint, the pin 800 and the counterpart slot 802 comprise locating and locking features. The locking features move aside for engagement with a mating part, followed by a return of the locking feature toward its original position. The locating features are inflexible, providing strength and stability. Naturally, the curry brush 124 may be removably coupled with the massage head 118 in another suitable way as well. For example, the curry brush 124 and the massage head 118 may be coupled with each other, alternatively, or additionally, by using magnets providing the required fixing force.

FIG. 8B illustrates an example embodiment of the apparatus 100, which now shows the curry brush 124 having been coupled with the massage head 118.

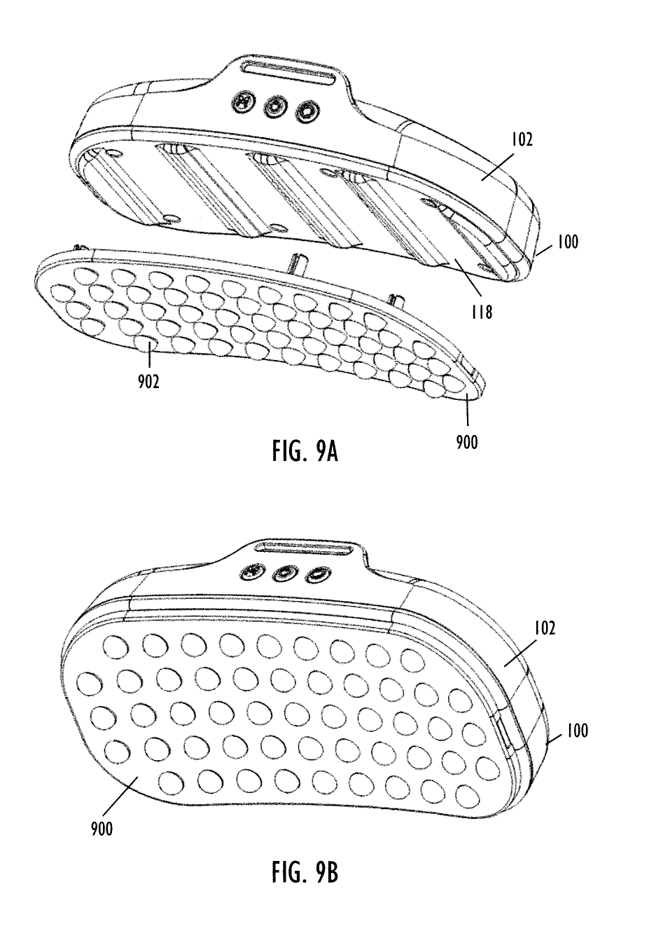

FIGS. 9A and 9B illustrate an example embodiment, wherein the massage head 118 is further adapted and dimensioned such that another curved interchangeable part 900 is coupleable with the massage head 118.

The other curved interchangeable part 900 comprises at least one of the following: another massaging head for the animal (200), a relaxing head for the animal 200, an acupuncture treatment head for the animal 200, a hair polishing head for the animal 200.

In FIGS. 9A and 9B, the other curved interchangeable part 900 comprises rounded studs 902, which may enhance the massage effect.

FIGS. 10A, 10B and 10C illustrate an example embodiment, wherein the at least two vibrators 106, 108, 110 are coupled with the housing 102 by a flexible and/or floating coupling such that the at least two vibrators 106, 108, 110 sway in relation to the housing 102 when in use. The swaying may further enhance the massage/grooming effect, and especially the variable beat frequency 504.

In an example embodiment, the flexible and/or floating coupling comprises at least one of the following: a double-sided adhesive tape coupling the vibrator 106, 108, 110 with the housing 102, and/or a cavity 1002, 1010 formed in the housing 102 to accommodate the vibrator 106, 108, 110 with a backlash.

As illustrated in FIGS. 10B and 10C, the structures 1000 and 1008 form the cavities 1002 and 1010. The recesses 1004, 1006 may be dimensioned such that they allow the vibrator to move 108 with the backlash, meaning that the fit is not very tight, but rather a loose one. Similar recesses may be in the structure 1008 as shown.

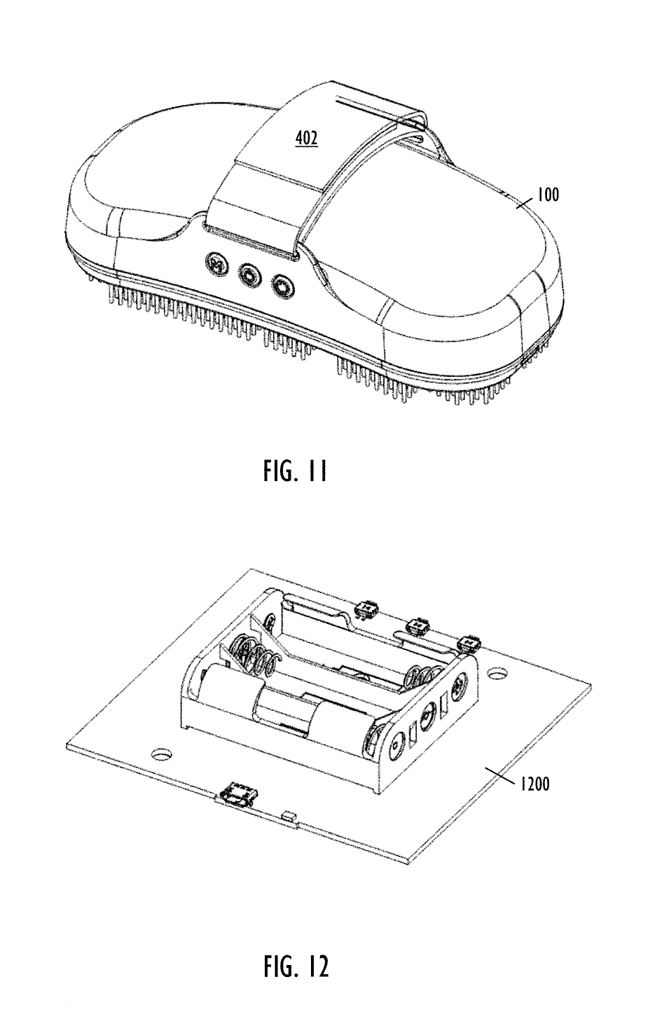

In an example embodiment, illustrated in FIGS. 4 and 11, the apparatus 100 further comprises a handle 402 adapted and dimensioned such that it is capable of accommodating one hand of a person 400 treating the animal 200 with the apparatus 100.

In an example embodiment, illustrated in FIGS. 1 and 12, the apparatus 100 further comprises a battery 114 to feed electric power to the at least two vibrators 106, 108, 110 and the controller 104. The housing 102 may comprise a battery compartment, such as illustrated in FIG. 12, wherein a detachable cover 1200 includes the battery compartment. The battery 114 may be a rechargeable battery, which may be charged 142 by an external power source 140, such as a battery charger. Alternatively, the battery 114 may be charged via the USB interface 128.

It will be obvious to a person skilled in the art that, as technology advances, the inventive concept can be implemented in various ways. The invention and its embodiments are not limited to the example embodiments described above but may vary within the scope of the claims.

1. A multi-purpose apparatus for treating an animal comprising:
at least two vibrators;
a massage head coupled with the at least two vibrators;
a controller configured to control the at least two vibrators such that they generate a variable beat frequency to the massage head; and
a housing accommodating the at least two vibrators, the massage head, and the controller;
wherein the massage head comprises a concave curvature to follow contours of the animal so that the concave curvature becomes in contact with a musculoskeletal system of the animal, the massage head is coupled with the at least two vibrators so that two vibrators are positioned at opposite ends of the concave curvature, and the massage head is adapted and dimensioned such that an interchangeable curry brush curved to follow the contours of the animal is coupleable with the massage head.

2. The apparatus of claim 1, wherein the apparatus further comprises an interface to receive a program for the controller to control the at least two vibrators in order to offer a predetermined grooming treatment for the animal with the apparatus, or a predetermined massage treatment for the animal with the apparatus.

3. The apparatus of claim 1, wherein the apparatus further comprises a temperature sensor to measure temperature of a skin of the animal treated with the apparatus, and the controller is further configured to control the variable beat frequency on the basis of the measured temperature such that at least one of the following is controlled: a frequency of the variable beat frequency, an amplitude of the variable beat frequency.

4. The apparatus of claim 1, wherein the apparatus further comprises a pressure sensor to measure a pressure subjected to a skin of the animal treated with the apparatus, and the controller is further configured to control the variable beat frequency on the basis of the measured pressure such that at least one of the following is controlled: a frequency of the variable beat frequency, an amplitude of the variable beat frequency.

5. The apparatus of claim 1, wherein the apparatus further comprises a strap attachable with the housing such that the apparatus is attachable to the animal, and a wireless radio transceiver to exchange control data with an external apparatus, and the controller is controlled by the control data in order to control a massage treatment of the animal with the apparatus.

6. The apparatus of claim 1, wherein the massage head is further adapted and dimensioned to be used for massaging the animal, and the massage head is further adapted and dimensioned such that another curved interchangeable part is coupleable with the massage head, the other curved interchangeable part comprising at least one of the following: another massaging head for the animal, a relaxing head for the animal, an acupuncture treatment head for the animal, a hair polishing head for the animal.

7. The apparatus of claim 1, wherein the at least two vibrators are coupled with the housing by a flexible and/or floating coupling such that the at least two vibrators sway in relation to the housing when in use.

8. The apparatus of claim 7, wherein the flexible and/or floating coupling comprises at least one of the following: a double-sided adhesive tape coupling the vibrator with the housing, and/or a cavity formed in the housing to accommodate the vibrator with a backlash.

9. The apparatus of claim 1, wherein the apparatus further comprises a handle adapted and dimensioned such that it is capable of accommodating one hand of a person treating the animal with the apparatus.

10. The apparatus of claim 1, wherein the apparatus further comprises a battery to feed electric power to the at least two vibrators and the controller.

11. The apparatus of claim 1, wherein the concave curvature is flexible and steplessly adjustable so that a user may flex the massage head such that the curvature is increased in order to follow the contours even more closely.

12. The apparatus of claim 1, wherein the concave curvature is rigid and stepwise adjustable as the massage head comprises sections that are pivotably lockable in relation to each other so that a user may adjust the massage head such that the curvature is increased in order to follow the contours even more closely.

13. The apparatus of claim 1, wherein curry brush is removably coupleable with the massage head with one of the following:
the curry brush comprises pins, the massage head comprises slots, and the pins and the slots form a snap-fit joint; or
the curry brush and the massage head are coupled with each other by using magnets providing the required fixing force.
